(19) United States
(12) Patent Application Publication
(10) Pub. No.: US 2004/0160384 A1
(43) Pub. Date: Aug. 19, 2004

(54) Hardware method for arranging dual-STN display data in a single memory bank to eliminate a half frame buffer

(76) Inventors: Eric Jeffrey, Richmond (CA); Barinder Singh Rai, Surrey (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/368,230

(22) Filed: Feb. 18, 2003

(51) Int. Cl. G09G 5/00

(52) U.S. Cl. 345/3.2

(57) ABSTRACT

Described is a device and method where pixel data in the display memory are stored such that data for a first display area and the corresponding location in a second display are stored within the same word. For example, the first pixel data in the upper half of the display would be stored in the one half of the word, while the first pixel data in the lower half of the display would be stored in the other half of the word. With the pixel data interleaved as described above, in one memory fetch the data can easily be split into upper and lower portions. Once split, the upper and lower data can be applied in parallel paths to frame rate modulation and dithering circuits and streamed to data formatting circuitry and on to the respective upper and lower display areas.

### BACKGROUND OF THE INVENTION

(1) Field of the Invention

The invention generally relates to display devices and, more particularly, to a method for supplying data to a display device.

(2) Description of Prior Art

A popular means of displaying information on using a liquid crystal display (LCD) employs super twisted pneumatic (STN) liquid crystals in a passive matrix. These displays are less expensive to manufacture than active matrix LCD displays such as those employing thin film transistors (TFTs). Because of their low cost, STN LCDs are popular for use in both portable and, more recently, desktop displays.

Unfortunately, STN displays have relatively short data retention and therefore need to be refreshed more often than an equivalent active matrix LCD. This requires that data from the display processor be sent at a faster rate for STN displays. Dual scan STN (DSTN) displays are currently employed to overcome this challenge.

FIGS. 1 and 2 illustrate in a block diagram the operation of a typical system employing a DSTN display. Referring now more particularly to FIG. 1, there is shown a DSTN display 10 having Z pixels labeled P₀ through P_{Z-1}. The DSTN display 10 is divided equally into an upper panel 10a and a lower panel 10b. The upper panel 10a contains X pixels labeled P₀ through P_{X-1}, where X is equal to one-half of Z. The lower panel 10b contains the remaining X pixels labeled P_{X} through P_{Z-1}. Data corresponding to each pixel are presented to the upper and lower data formatters (16a and 16b, respectively), which supply data to the upper and lower panels 10a and 10b. The formatters 16a and 16b convert pixel data into a format useable by the display 10. Each individual pixel can only be on or off; therefore individual pixel data are one bit in length for monochrome displays (f=1) and three bits in length for color displays (f=3; one each for red, green, and blue). The half frame buffer 12 contains X memory locations and is used to store pixel area data for either the upper panel 10a or lower panel 10b. The display memory 14 (typically SRAM) contains Z memory locations (D₀ through D_{Z-1}) corresponding to pixels P₀ through P_{Z-1}. Data from the display memory 14 (having length of typically 4, 8, 16 or 24 bits) are applied to frame rate modulation and dithering (FRM/D) circuitry 20 where they are converted to individual pixel data of either one (monochrome) or three (color) bits.

As shown in FIG. 1, the half frame buffer 12 currently stores the lower panel 10b pixel data (P_{X} through P_{Z-1}). This was stored during a previous display refresh cycle. At the initiation of this “first” refresh cycle, display data beginning at D₀ from the display memory 14 will sequentially be sent through the FRM/D circuitry 20 thereby outputting pixel data beginning at P₀. This pixel data is sent directly to the upper data formatter 16a. Simultaneously, pixel data beginning at P_{X} from the half frame buffer 12 will sequentially be written to the lower data formatter 16b. The upper data formatter 16a writes pixel data to the upper panel 10a, while the lower data formatter 16b writes pixel data to the lower panel 10b. When both the upper panel 10a and lower panel 10b pixel data have been written, the DSTN display 10 will have been refreshed. Additionally, as pixel data are streamed from the FRM/D circuitry 20 to the upper panel 10a during this refresh cycle, they are also applied to the input of the half frame buffer 12 thereby overwriting the data in the half frame buffer 12. Thus at the end of this “first” refresh cycle, the pixel data stored in the half frame buffer 12 will correspond to pixel areas P₀ through P_{X-1} as shown in FIG. 2.

Referring now more particularly to FIG. 2, the “second” refresh cycle is initiated. Display data beginning at D_{X} from the display memory 14 will sequentially be sent through the FRM/D circuitry 20 thereby outputting pixel data beginning at P_{X}. This pixel data is sent to the lower data formatter 16b and directly to the lower panel lob. As pixel data are streamed from the FRM/D circuitry 20 to the lower data formatter 16b, they are also over writing the pixel data in the half frame buffer 12. Simultaneously, pixel data beginning at P₀ from the half frame buffer 12 will sequentially be written to the upper panel 10a via the upper data formatter 16a. When both the upper panel 10a and lower panel 10b pixel data have been written, the DSTN display 10 will have been refreshed and at the end of this “second” refresh cycle, the pixel data stored in the half frame buffer 12 will correspond to pixel areas P_{X} through P_{Z-1} as originally shown in FIG. 1.

These “first” and “second” refresh cycles are repeated thereby alternating application of data from the SRAM 14 through the FRM/D circuitry 20 to one of the panel halves 10a or 10b while simultaneously using pixel data from the half frame buffer 12 to refresh the other of the panel halves 10a or 10b. U.S. Pat. No. 5,945,974 to Sharma et al. teaches a method and circuit employing the half frame buffer in an integrated controller. The problem with this methodology is that the half frame buffer must be able to store half of the pixel data. For larger displays, the size and speed requirement of the half frame buffer becomes impractical.

Other methods have been devised for improvement of display devices. U.S. Pat. No. 5,617,113 to Prince describes a system using three memory areas. At any given interval, two of the memory areas will contain pixel data corresponding to the upper and lower halves of the display. While these data are sent to the display, the third memory is overwritten by new pixel data corresponding to one half of the display. Once the third memory is overwritten, it will replace the previous memory supplying that data. The retired data will than be overwritten and the process repeated. U.S. Pat. No. 5,877,741 to Chee et al. describes a graphics controller employing two pipelines. One pipeline is dedicated to background graphics data while the other stores overlay display data. In addition, the controller uses a tiered arbitration scheme to permit memory access thereby improving system throughput.

### SUMMARY OF THE INVENTION

A principal object of the present invention is to provide a method for eliminating the need for a half frame buffer in a dual super twisted pneumatic (DSTN) passive matrix display.

A second object of the present invention is to provide a device for eliminating the need for a half frame buffer in a dual super twisted pneumatic (DSTN) passive matrix display.

Another object of the present invention is to provide a method for eliminating the need for a half frame buffer in a dual super twisted pneumatic (DSTN) passive matrix display whereby display refresh can be accomplished in one memory cycle.

Another object of the present invention is to provide a device for eliminating the need for a half frame buffer in a dual super twisted pneumatic (DSTN) passive matrix display whereby display refresh can be accomplished in one memory cycle.

A still further object of the present invention is to provide a method for interleaving pixel data for a first and a second display area.

A yet further object of the present invention is to provide a device for interleaving pixel data for a first and a second display area.

These objects are achieved using a device and method where pixel data in the display memory are stored such that data for a first display area and the corresponding location in a second display are stored within the same word. For example, the first pixel data in the upper half of the display would be stored in the one half of the word, while the first pixel data in the lower half of the display would be stored in the other half of the word. If, for example, the pixel data uses a width of 16 bits-per-pixel (16 bpp) while using a 32-bit word length memory, 16 bits would be designated for the upper half display pixel data and the remaining 16 bits would contain lower half display pixel data. For a 8 bpp width, the 32-bit memory would store two upper and two lower display pixels per word.

With the pixel data interleaved as described above, in one memory fetch the data can easily be split into upper and lower portions. Once split, the upper and lower data can be applied in parallel paths to data formatting circuitry and on to the respective upper and lower display areas.

### BRIEF DESCRIPTION OF THE DRAWINGS

In the accompanying drawings forming a material part of this description, there is shown:

FIGS. 1 and 2 illustrating the operation of prior art example of a dual super twisted pneumatic (DSTN) passive matrix display employing a half frame buffer;

FIG. 3 illustrating in block diagram format one embodiment of the device and method for interleaving upper and lower display area pixel data of the present invention;

FIG. 4 illustrating in block diagram format the display memory organization after interleaving the upper and lower display area pixel data of the present invention; and

FIG. 5 illustrating in block diagram format an embodiment of the present invention whereby the interleaved data is applied to the display data.

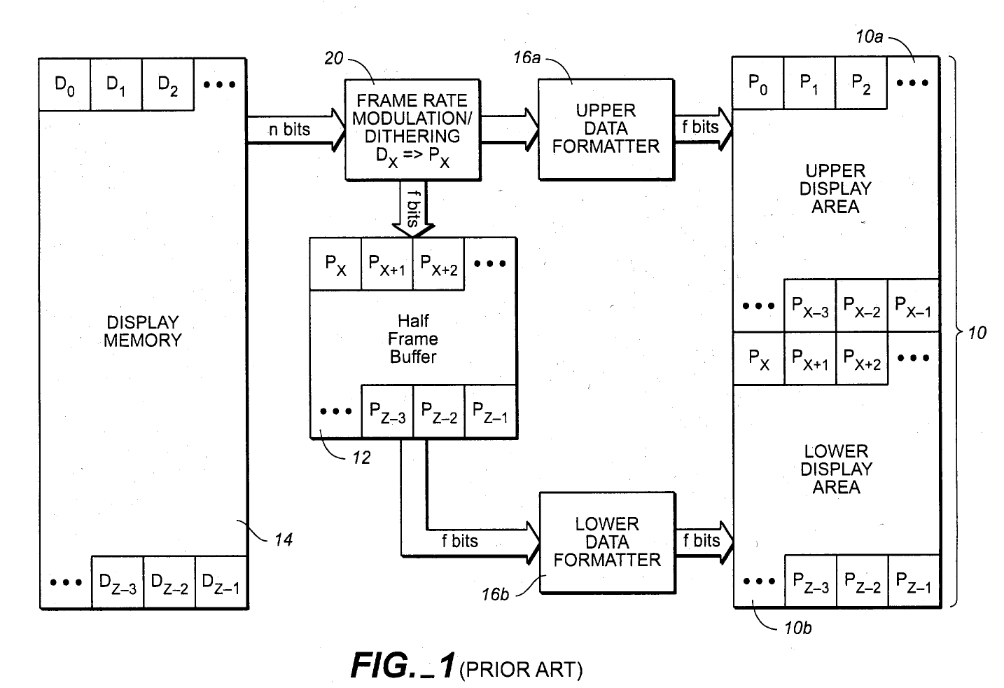

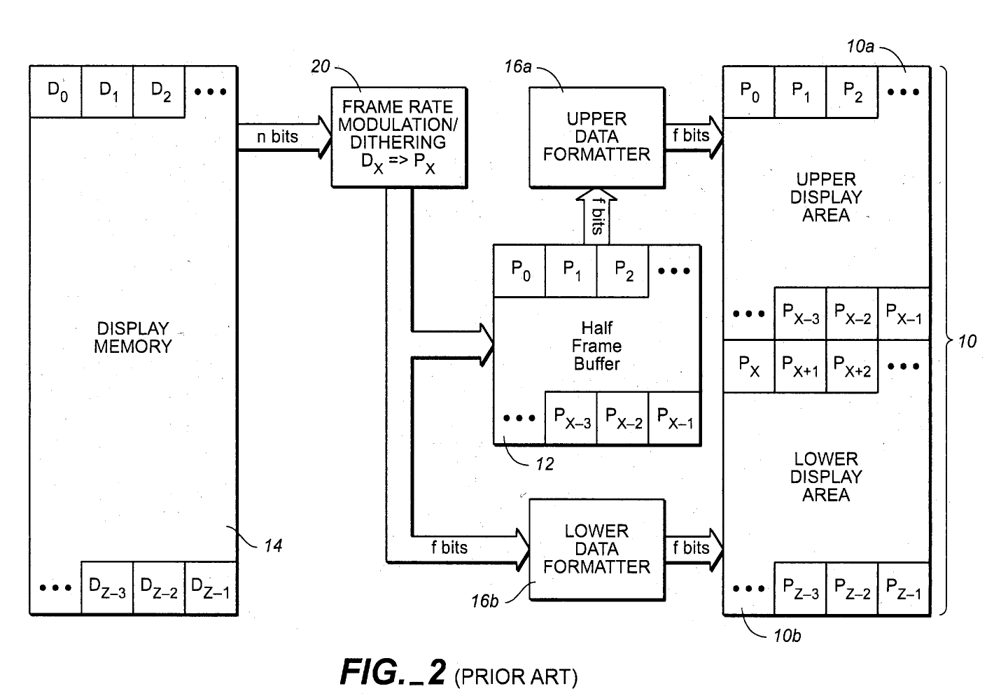

### DESCRIPTION OF THE PREFERRED EMBODIMENTS

The present invention uses an interleaved pixel data storage format to eliminate the need for the half frame buffer in a display system. While the embodiment described herein refers to a dual area display system having upper and lower display areas those skilled in the art will understand that the method could be expanded to systems having more than two distinct display areas. For clarity, data in the display memory prior to application to the frame rate modulation and dithering (FRM/D) circuitry will hereafter be referred to as display data (Dᵢ) and data having been processed by the FRM/D circuitry will hereafter be referred to as pixel data (Pᵢ).

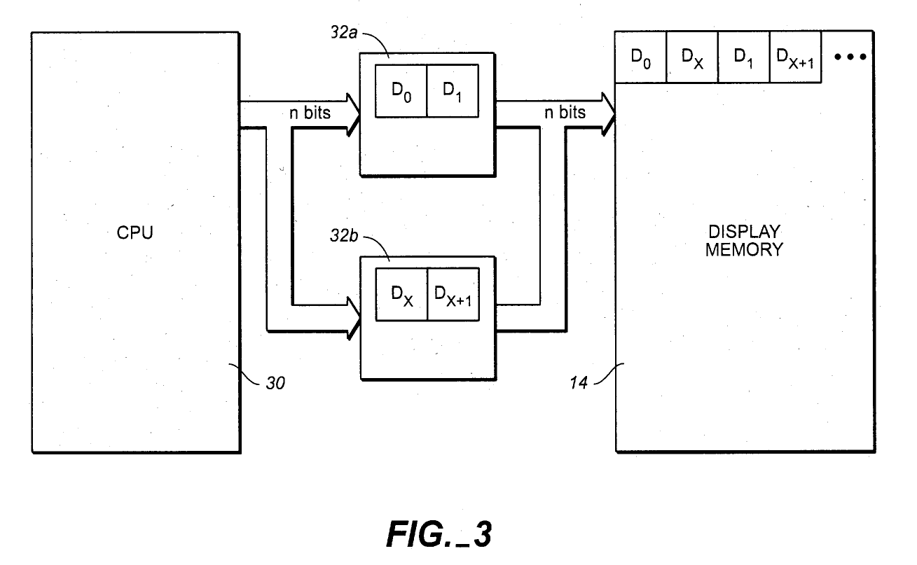

Refer now to FIG. 3, showing a block diagram of one embodiment of the present invention used to interleave the upper and lower display data. For this example a 32-bit word length display memory 14 is used. This length could be varied without changing the spirit of the interleaving concept. In addition, for this example a display data width of 16 bits-per-pixel (bpp) is used and one pixel of upper display data and one pixel of lower display data are stored within each one 32-bit word. If 8 bpp are used (not shown), two upper display data words and two lower display data words are interleaved and stored within each 32-bit word. In the example, a display of Z pixels is used. The upper pixel display data are labeled in P₀ through P_{X-1} and the lower pixel display data are labeled in P_{X} through P_{Z-1}.

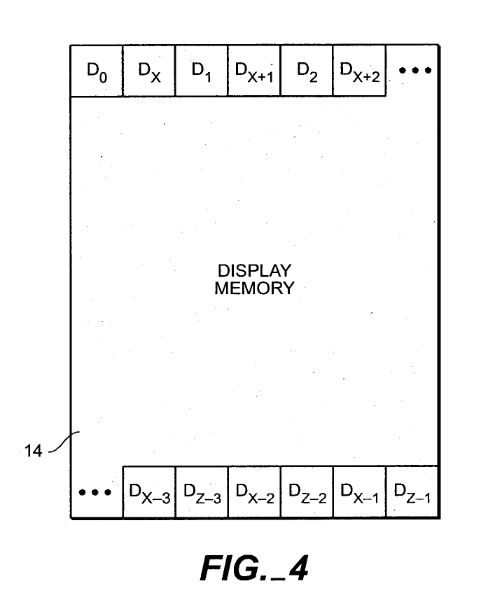

Still referring to FIG. 3, display data is output from the central processing unit (CPU) 30. The data from the CPU 30 are transmitted in the same format as that used in the prior art example. However, in the prior art, these data would be sent directly to the display memory for storage. In the present invention, these data are first stored into upper and lower registers 32a and 32b, respectively. For example, display data words D₀ and D₁, corresponding to the first two pixels in the upper half of the display are presented in one memory cycle. These data are stored in upper register 32a. In the next memory cycle, the CPU 30 presents display data words D_{X} and D_{X+1} corresponding to the first and second pixels of the lower half of the display. These data are stored in lower register 32b. Once both registers 32a and 32b have data, these data are interleaved by taking the first half data of the upper and lower registers 32a and 32b and storing them into display memory 14 and then taking the second half data of the upper and lower registers 32a and 32b and storing them into display memory 14. The process is then repeated for upper display data words D₂ and D₃ and lower display data words D_{X+2} and D_{X+3} (not shown), and so on until the display memory 14 is filled with interleaved data as depicted in FIG. 4. Note that two memory write cycles are required to write two words of data to the memory, thus no additional memory cycles are required over having the CPU 30 writing directly to the display memory 14. The CPU 30 could carry out the interleaving of the display data directly, but this method simplifies writing the display image data to display memory 14 without interfering with the CPU throughput.

While many schemes may be employed to interleave the upper and lower pixel data in memory, the key elements of the present invention are in using the interleaved data to simplify the display system and to eliminate the need for a half frame buffer.

Referring now more particularly to FIG. 4, the organization of the display memory 14 after interleaving is shown. The display memory would, for example, be a static random access memory (SRAM). In this example, each 32-bit word contains one display data word of upper and one display data word of lower data each with a width of 16 bpp. If 8 bpp (not shown) are used with a 32-bit word display memory 14, the data would alternate two pixels of upper data and two pixels of lower data. Regardless of memory word length, the upper display data and lower display data should appear in specific word lines (For example in a 32-bit word memory, outputs Q₀₋₁₅ for upper display data words and outputs Q₁₆₋₃₁ for lower display data words).

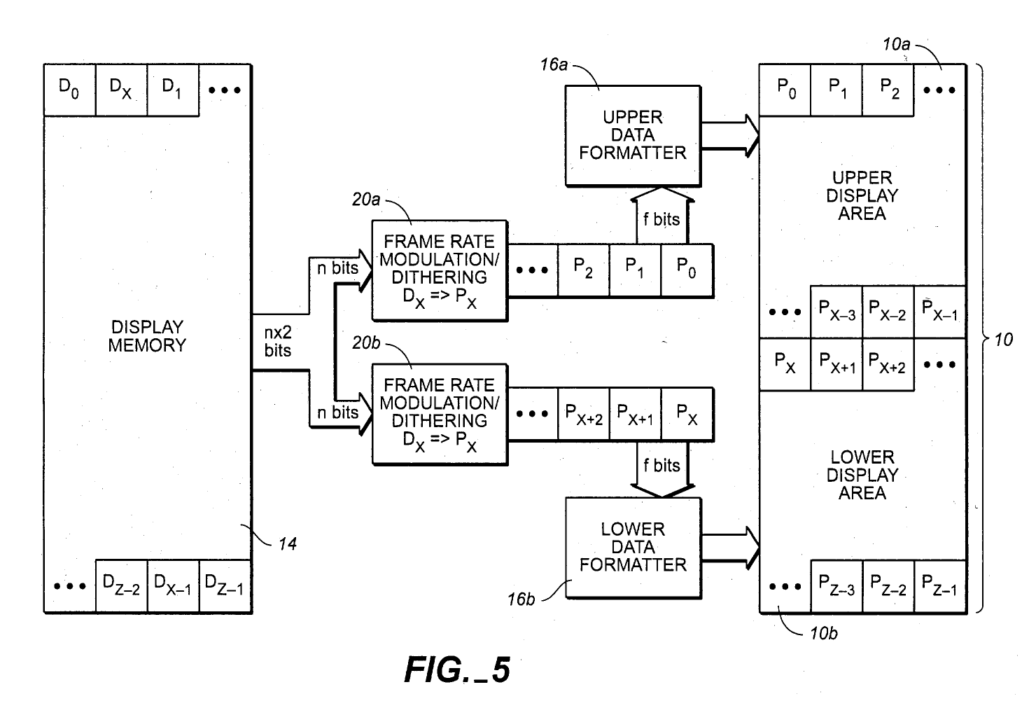

Refer now to FIG. 5, depicting in block diagram format a key element of the present invention. FIG. 5 illustrates the system for employing the interleaved pixel data to drive the display 10. The example uses the display memory 14 with a 2n-bit word length memory with each word divided equally into upper pixel and lower display data halves each containing n bits. As display data are requested from the display memory 14, the upper display data are presented to the input of the upper frame rate modulation and dithering (FRM/D) circuitry 20a, while the lower data are presented to the lower FRM/D circuitry 20b. The FRM/D circuitries (20a and 20b) convert the n-bit display data into pixel data f bits (f=1 for monochrome; f=3 color) in length. Data from the upper FRM/D circuitry 20a are presented to the upper data formatter 16a whereby the upper data formatter 16a drives the upper half of the display panel 10a. Simultaneously, data from the lower FRM/D circuitry 20b are presented to the lower data formatter 16b, which in turn drives the lower half of the display panel 10b. While the prior art and present invention refresh the upper and lower displays 10a and 10b simultaneously, the present invention can perform the refresh cycle more quickly.

The present invention is a device and method where upper and lower pixel data in the display memory are interleaved within the same word. With the pixel data interleaved, it is easily separated into upper and lower portions during a single memory reading. The upper and lower pixel data can then be applied in parallel paths to respective upper and lower FRM/D circuitry, streamed to formatting circuitry and presented to the respective display areas. Additionally, the present invention teaches one embodiment of a method and device for interleaving the pixel data within the display memory. This embodiment uses an upper and lower register for temporary storage of data prior to being formatted for storage within the display memory requiring no additional CPU memory cycles for storage of data to the display memory. While the embodiment described uses only two display areas, the method could be expanded to systems with more than two display areas.

While the invention has been particularly shown and described with reference to the preferred embodiments thereof, it will be understood by those skilled in the art that various changes in form and details may be made without departing from the spirit and scope of the invention.

What is claimed is:

1. A display device comprising:
a display having a plurality of J distinct display areas wherein each of said J distinct display areas is comprised of a plurality of X pixel addresses corresponding to a specific pixel location;
a memory having a word length of at least M bits and a capacity of at least X words wherein each of said X words is mapped to one of said X pixel addresses;
a data interleaving device for interleaving pixel display data words wherein pixel display data words will be stored within said memory such that each of said X words will comprise a concatenation of individual pixel display data words having length of M/J bits corresponding to each of said J distinct display areas;
a plurality of J frame rate modulation and dithering circuits wherein said pixel display data words are converted to individual pixel data; and
a plurality of J formatting circuits wherein said individual pixel data from each of said J frame rate modulation and dithering circuits are presented to the input of one of said formatting circuits and wherein the output of each of said formatting circuits is presented to one of said X pixel addresses corresponding to a specific pixel location thereby illuminating said pixel location.

2. The device according to claim 1 wherein said interleaving device comprises a plurality of J data registers each having a capacity of at least M bits wherein said interleaving is accomplished by:
sequential storing of said pixel display data words from a central processing unit into each of said registers wherein each of said registers only receives said pixel display data words corresponding to one of said distinct display areas and wherein each of said registers contains J of said pixel display data words of length M/J bits corresponding to said pixel locations that are adjacent within one of said distinct display areas;
sequential concatenation and then storing into said memory, J of said pixel display data words of length M/J bits stored in said registers into J words M bits in length wherein each of said M bit words comprises said pixel display data words from all of the J distinct display areas at only one of said pixel addresses; and
repeating said sequential storing, said sequential concatenation and said storing of pixel display data words and until all of said X pixel addresses have been written to memory.

3. The device according to claim 1 wherein said data interleaving is performed by a central processing unit.

4. The device according to claim 1 wherein said J is two.

5. The device according to claim 1 wherein said M is 32.

6. The device according to claim 1 wherein said display comprises super twisted pneumatic (STN) liquid crystals.

7. The device according to claim 1 wherein said display comprises thin film transistors (TFT).

8. The device according to claim 1 wherein said memory comprises a static random access memory (SRAM).

9. A display device comprising:
a display having two distinct display areas wherein each of said display areas is comprised of a plurality of X pixel addresses corresponding to a specific pixel location;
a memory having a word length of 32 bits and a capacity of at least X words wherein each of said X words is mapped to one of said X pixel addresses;
a data interleaving device for interleaving pixel data wherein pixel display data words will be stored within said memory such that each of said X words will comprise a concatenation of individual pixel display data words having length of sixteen bits corresponding to each of said display areas;
two data frame rate modulation and dithering circuits wherein said pixel display data words are converted to individual pixel data; and
two formatting circuits wherein said individual pixel data from each of said frame rate modulation and dithering circuits are presented to the input of one of said formatting circuits and wherein the output of each of said formatting circuits is presented to one of said X pixel addresses corresponding to a specific pixel location thereby illuminating said pixel location.

10. The device according to claim 9 wherein said interleaving device comprises two data registers each having a capacity of 32 bits wherein said interleaving is accomplished by:
sequential storing of said pixel display data words from a central processing unit into each of said registers wherein each of said registers only receives said pixel display data words corresponding to one of said distinct display areas and wherein each of said registers contains two of said pixel display data words of length sixteen bits corresponding to said pixel locations that are adjacent within one of said display areas;
sequential concatenation and then storing into said memory two of said pixel display data words of length sixteen bits stored in said registers into two words 32 bits in length wherein each of said 32 bit words comprises said pixel display data words from both of said display areas at only one of said pixel addresses; and
repeating said sequential storing, said sequential concatenation and said storing of pixel data and until all of said X pixel addresses have been written to memory.

11. The device according to claim 9 wherein said data interleaving is performed by a central processing unit.

12. The device according to claim 9 wherein said display comprises super twisted pneumatic (STN) liquid crystals.

13. The device according to claim 9 wherein said display comprises thin film transistors (TFT).

14. The device according to claim 9 wherein said memory comprises a static random access memory (SRAM).

15. A device for interleaving pixel display data words comprising:
an upper data register and a lower data register each having a capacity of 32 bits wherein said interleaving is accomplished by:
sequential storing of said pixel display data words from a central processing unit into each of said registers wherein said upper register receives said pixel display data words corresponding to pixel locations that are adjacent within an upper half of a display and said lower register receives said pixel display data words corresponding to pixel locations that are adjacent within a lower half of said display;
concatenation of the first sixteen of 32 bits of said upper register with the first sixteen of 32 bits of said lower register and then storing said concatenation into said memory;
concatenation of the last sixteen of 32 bits of said upper register with the last sixteen of 32 bits of said lower register and then storing said concatenation into said memory; and
repeating said sequential storing, said concatenation of said first sixteen of 32 bits of said upper register with said first sixteen of 32 bits of said lower register and then storing said concatenation into said memory and said concatenation of said last sixteen of 32 bits of said upper register with said last sixteen of 32 bits of said lower register and then storing said concatenation into said memory until all of said display pixel data are written to said memory.

16. The device according to claim 15 wherein said memory comprises a static random access memory (SRAM).

17. A method for displaying images comprising:
storing pixel display data words in a memory having a word length of at least M bits and a capacity of at least X words wherein each of said X words is mapped to one of X pixel addresses within one of J distinct areas on a display device wherein said pixel display data words will be stored within said memory such that each of said X words will comprise a concatenation of individual pixel data having length of M/J bits from each of said J distinct display areas on said display device;
sequentially presenting each of said X words from said memory to the input of a plurality of J frame rate modulation and dithering circuits wherein said pixel display data words are converted to individual pixel data;
presenting said individual pixel data from said output of each of said frame rate modulation and dithering circuits to the input of one of J formatting circuits wherein each of said J formatting circuits is mapped to one of said J distinct display areas on said display device; and
presenting the output of each of said formatting circuits to one of said X pixel addresses corresponding to a specific pixel location within one of said J distinct display areas on said display device and thereby illuminating said pixel location.

18. The method according to claim 17 wherein said J is two.

19. The method according to claim 17 wherein said M is 32.

20. The method according to claim 17 wherein said display comprises super twisted pneumatic (STN) liquid crystals.

21. The method according to claim 17 wherein said display comprises thin film transistors (TFT).

22. The method according to claim 17 wherein said memory comprises a static random access memory (SRAM).

23. A device for formatting data for presentation to a display wherein said display has a plurality of J distinct display areas and each of said J distinct display areas is comprised of a plurality of X pixel addresses corresponding to a specific pixel location comprising:
a memory having a word length of at least M bits and a capacity of at least X words wherein each of said X words is mapped to one of said X pixel addresses;
a data interleaving device for interleaving pixel display data words wherein pixel display data words will be stored within said memory such that each of said X words will comprise a concatenation of individual pixel display data words having length of M/J bits corresponding to each of said J distinct display areas;
a plurality of J frame rate modulation and dithering circuits wherein said pixel display data words are converted to individual pixel data; and
a plurality of J formatting circuits wherein said individual pixel data from each of said J frame rate modulation and dithering circuits are presented to the input of one of said formatting circuits and wherein the output of each of said formatting circuits are pixel data corresponding to specific pixel locations within one of said J distinct display areas.

24. The device according to claim 23 wherein said interleaving device comprises a plurality of J data registers each having a capacity of at least M bits wherein said interleaving is accomplished by:
sequential storing of said pixel display data words from a central processing unit into each of said registers wherein each of said registers only receives said pixel display data words corresponding to one of said distinct display areas and wherein each of said registers contains J of said pixel display data words of length M/J bits corresponding to said pixel locations that are adjacent within one of said distinct display areas;
sequential concatenation and then storing into said memory, J of said pixel display data words of length M/J bits stored in said registers into J words M bits in length wherein each of said M bit words comprises said pixel display data words from all of the J distinct display areas at only one of said pixel addresses; and
repeating said sequential storing, said sequential concatenation and said storing of pixel display data words and until all of said X pixel addresses have been written to memory.

25. The device according to claim 23 wherein said data interleaving is performed by a central processing unit.

26. The device according to claim 23 wherein said J is two.

27. The device according to claim 23 wherein said M is 32.

28. The device according to claim 23 wherein said memory comprises a static random access memory (SRAM).
